(19) United States
(12) Patent Application Publication
(10) Pub. No.: US 2016/0345487 A1
(43) Pub. Date: Dec. 1, 2016

(54) Dibbler

(71) Applicant: YU-YING WANG, Taichung City 4 (TW)

(72) Inventor: YUNR-FENG LIAO, Taichung City (TW)

(21) Appl. No.: 14/723,432

(22) Filed: May 27, 2015

(51) Int. Cl. A01C 7/02; A01C 7/00

(52) U.S. Cl. CPC A01C 7/02; A01C 7/002

(57) ABSTRACT

A dibbler includes a tube, a digging unit, a handle unit and an anchor. The digging unit is connected to a lower end of the tube and formed with a digging portion. The handle unit is connected to the tube and the digging unit. The anchor is connected to the digging unit and formed with a tip extending beyond than the digging portion.

### BACKGROUND OF INVENTION

1. Field of Invention

The present invention relates to a dibbler and, more particularly, to a precision dibbler.

2. Related Prior Art

In early days, seed or seedling was planted in soil by bare hands, and this is exhausting.

To solve this problem, a dibbler was devised, and Taiwanese Patent No. 517508 was issued for the dibbler. The dibbler includes a tube, a blocking element and a shovel. A lower tip of the blocking element and a lower tip of the shovel can be inserted in the soil. The shovel can be pivoted so that the lower tip thereof pushes away some of the soil and makes a plant hole. The dibbler saves a farmer a lot of labor involved in bending, stooping, digging and setting.

However, the dibbler is not used without any problems. For example, the dibbler cannot be precisely positioned when it is used for soil covered by a weed barrier. In such an operation, the lower tip of the blocking element and the lower tip of the shovel are inserted in the earth. Then, the lower tip of the shovel is pivoted to push away some of the soil when the lower tip of the blocking element is expected to stay in position. The lower tip of the blocking element has been proved insufficient to stay in position when the lower tip of the shovel pushes way the soil. Hence, plants cannot be precisely separated by desired gaps. This is because the lower tip of the blocking element is positioned at a same depth in the earth as the lower tip of the shovel.

Moreover, the blocking element tends to push a portion of the weed barrier before the plant is dropped into the plant hole through the tube. This portion of the weed barrier tends to restore its original position after the lower tip of the blocking element is removed from the earth after the plant is dropped into the plant hole. This restoring portion of the weed barrier tends to cover the plant, prevent the plant from photosynthesis, and kill the plant.

Furthermore, it is difficult to insert the lower tip of the blocking element into the earth because the blocking element includes a flat lower tip. Hence, the farmer has to exert a large force on the dibbler, and the lower tip of the blocking element is worn away easily.

The present invention is therefore intended to obviate or at least alleviate the problems encountered in prior art.

### SUMMARY OF INVENTION

It is the primary objective of the present invention to provide a precision dibbler.

To achieve the foregoing objective, the dibbler includes a tube, a digging unit, a handle unit and an anchor. The digging unit is connected to a lower end of the tube and formed with a digging portion. The handle unit is connected to the tube and the digging unit. The anchor is connected to the digging unit and formed with a tip extending beyond than the digging portion.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a dibbler according to the preferred embodiment of the present invention;

FIG. 2 is an exploded view of the dibbler shown in FIG. 1;

FIG. 3 is a side view of the dibbler shown in FIG. 1;

FIG. 4 is a front view of the dibbler shown in FIG. 1; and

FIG. 5 is a front view of the dibbler in another position than shown in FIG. 1.

### DETAILED DESCRIPTION OF PREFERRED EMBODIMENT

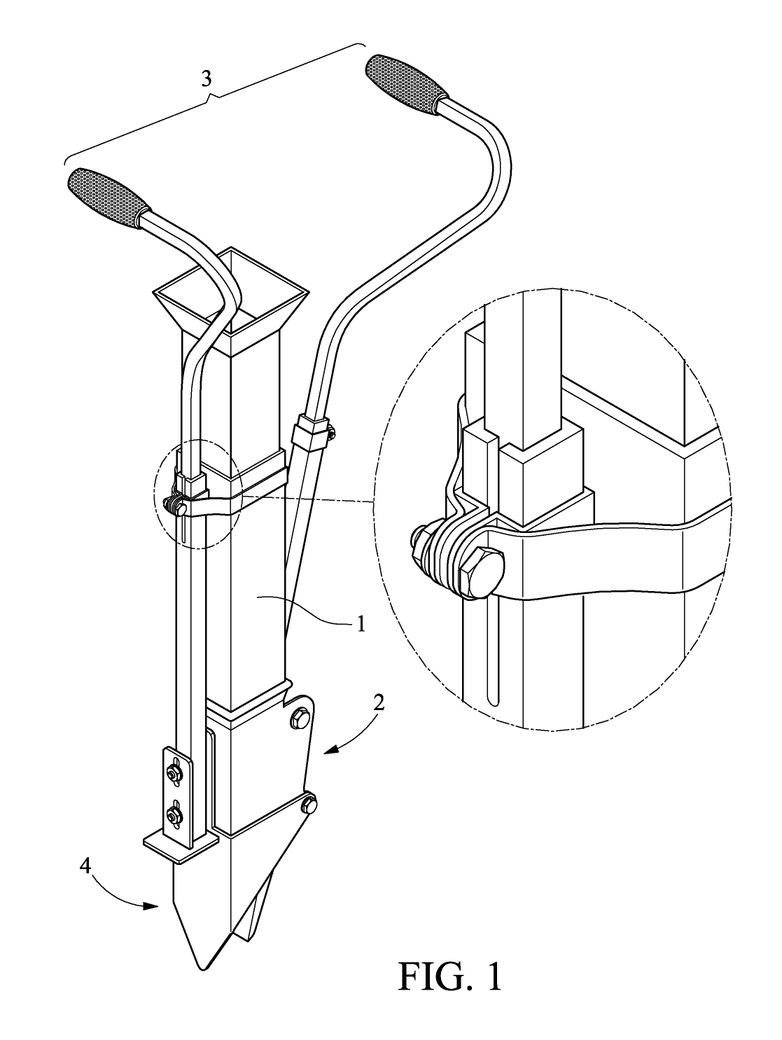

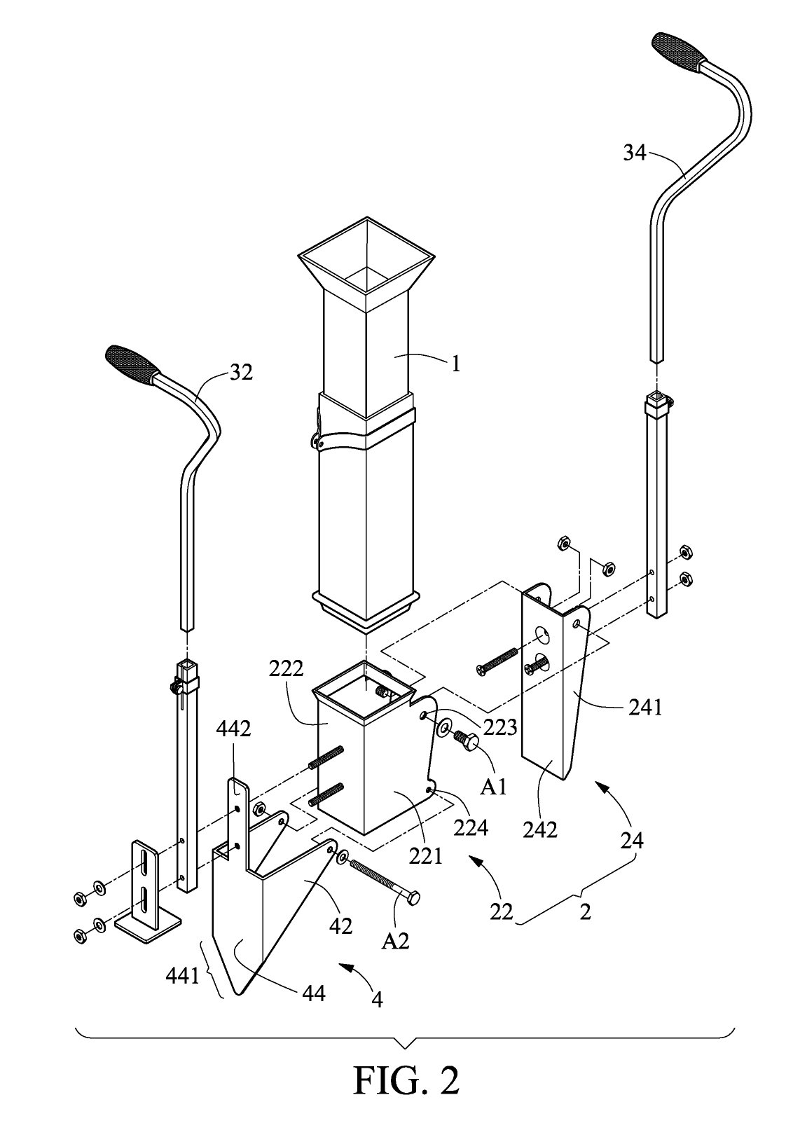

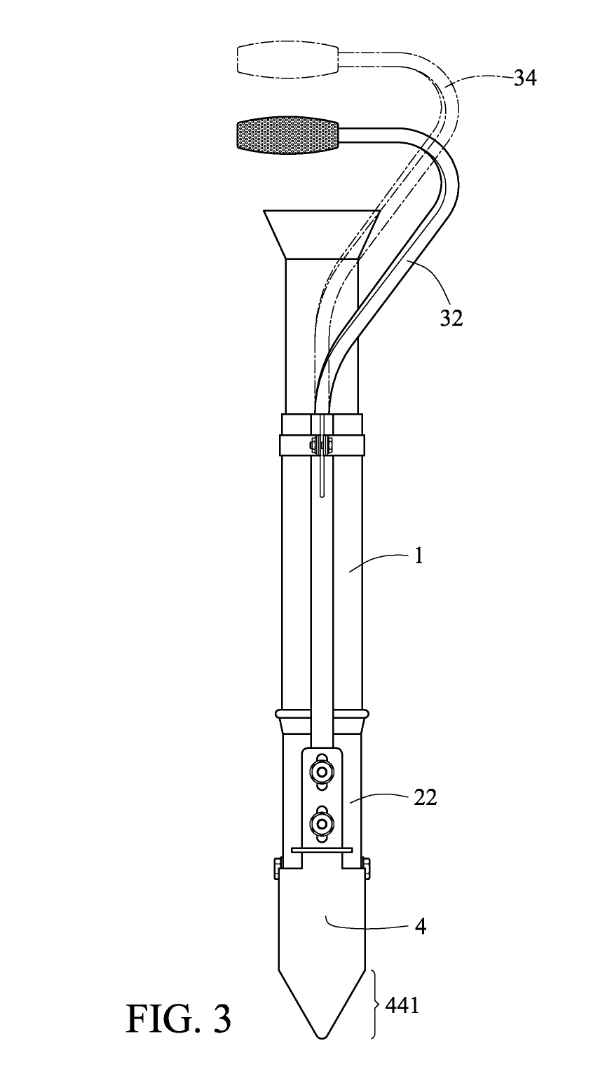

Referring to FIGS. 1 through 5, a dibbler includes a tube 1, a digging unit 2 attached to a lower end of the tube 1, a handle unit 3 connected to the tube 1 the digging unit 2, and an anchor 4 provided around and attached to a lower end of digging unit 2 according to the preferred embodiment of the present invention. The tube 1 is a conventional element and will not be described in detail.

The digging unit 2 is a conventional unit and includes a blocking element 22 and a shovel 24. The blocking element 22 is made of a metal strip, and includes two identical lateral plates 221 and a middle plate 222 formed between the lateral plates 22. The blocking element 22, which includes the middle plate 222 and the lateral plates 221, is secured to the lower end of the tube 1 in a conventional manner such as welding. Each of the lateral plates 221 of the blocking element 22 includes two apertures 223 and 224. The apertures 223 and 224 are located near an edge of each of the lateral plates 221 opposite to the middle plate 222. The aperture 223 is located higher than the aperture 224.

The shovel 24 is made of a metal strip, and includes two identical triangular lateral plates 241 and a digging plate 244 formed between the triangular lateral plates 241. The digging plate 244 of the shovel 24 includes a digging portion 242. The lateral plates 241 of the shovel 24 are located between the lateral plates 221 of the blocking element 22. Then, a fastener such as a screw Al is inserted in the apertures 223 made in the lateral plates 221 of the blocking element 22 and two apertures (not numbered) made in the lateral plates 241 of the shovel 24. Thus, the shovel 24 is movably and, more particularly, pivotally connected to the blocking element 22. The shovel 24 can be pivoted about the fastener A1 between two positions.

The handle unit 3 is a conventional unit and includes a stationary handle 32 located on a side of the tube 1 and a movable handle 34 located on another side of the tube 1. The stationary handle 32 includes a portion connected to the tube 1 and another portion connected to the middle plate 222 of the blocking element 22. The movable handle 34 includes a portion connected to the digging plate 244 of the shovel 24. The movable 34 can be moved and, more particularly, pivoted between two positions.

The anchor 4 is made of a metal strip, and includes two identical triangular lateral plates 42 and an inserting plate 44 formed between the triangular lateral plates 42. The inserting plate 44 of the anchor 4 includes a tip 441 formed at an end and a shank 442 formed at an opposite end. The tip 441 of the inserting plate 44 is sharp. The tip 441 of the inserting plate 44 of the anchor 4 extends beyond the digging portion 242 of the digging plate 244 of the shovel 24.

In assembly, the shank 442 of the anchor 4 is located between the stationary handle 32 and the middle plate 222 of the blocking element 22. The lateral plates 221 of the blocking element 22 are located between the lateral plates 42 of the anchor 4. Two fasteners such as screws (not numbered) are inserted in the shank 442 of the anchor 4, the stationary handle 32 and the middle plate 222 of the blocking element 22. A fastener such as a screw A2 is inserted in two apertures (not numbered) made in the lateral plates 42 of the anchor 4 and the apertures 224 made in the lateral plates 221 of the blocking element 22. Thus, the blocking element 22, the stationary handle 32 and the anchor 4 are firmly connected to one another. Moreover, the fastener A2 is used to limit the pivoting of the shovel 24.

The anchor 4 and the blocking element 22 are made separately before they are connected to each other according to the preferred embodiment. However, the anchor 4 and the blocking element 22 can be made one in accordance with another embodiment.

In use, the handle unit 3 is operated to insert the digging unit 2 and the anchor 4 into soil 5. During the insertion, the tip 441 of the inserting plate 44 of the anchor 4 pieces a weed barrier 51 used to cover the soil 5. The anchor 4, which includes the inserting plate 44 and the lateral plates 42, makes a flip 511 of the weed barrier 51.

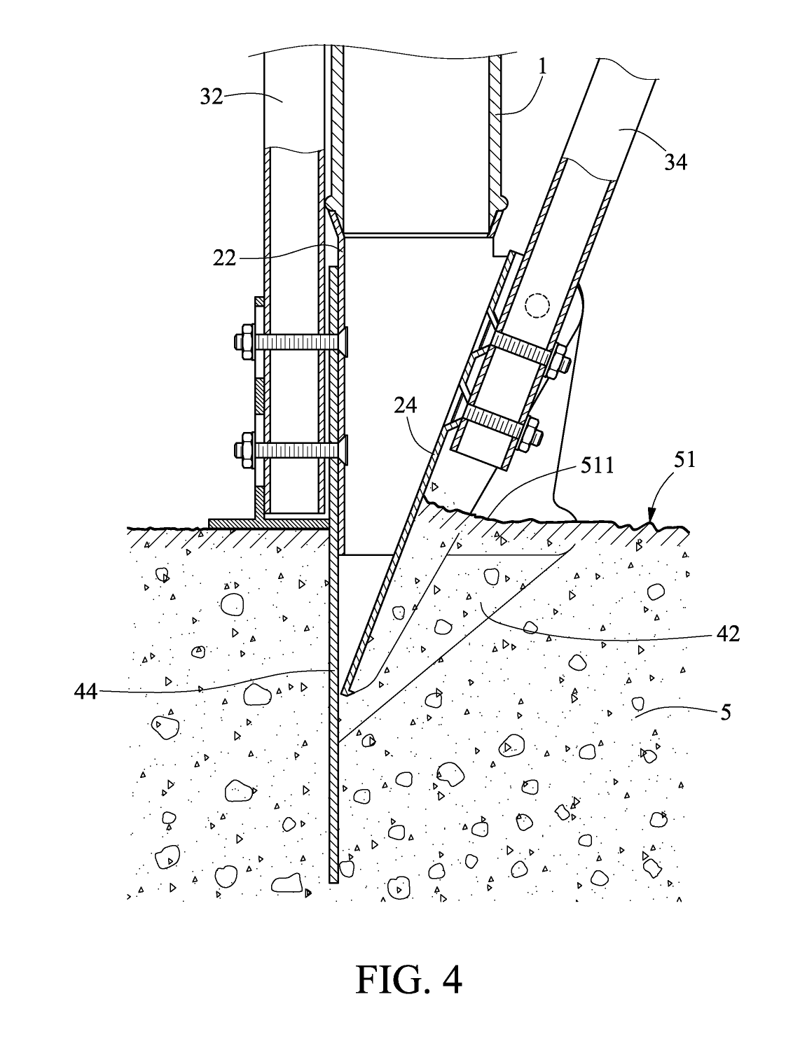

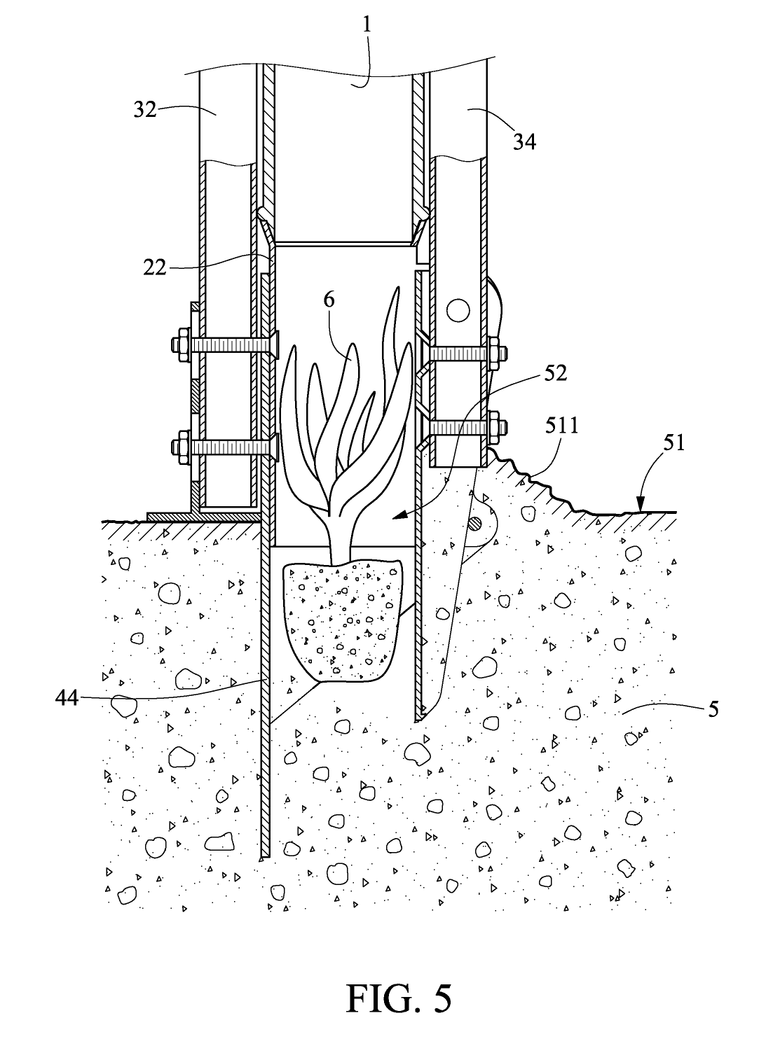

After each of the anchor 4 and digging unit 2 is partially inserted in the soil 5, the movable handle 34 is pivoted about the fastener A1. The shovel 24 is hence pivoted from the first position (FIG. 4) into the second position (FIG. 5). During the pivoting into the second position from the first position, the shovel 24 pushes away some of the soil 5 as well as the flip 511.

Advantageously, the anchor 4 is inserted in the soil 5 deeper than the shovel 24 because the tip 441 of the inserting plate 44 of the anchor 4 extends beyond the digging portion 242 of the digging plate 244 of the shovel 24 as mentioned above. The area of contact of the inserting plate 44 with the soil 5 is larger than the area of contact of the digging plate 24 with the soil 5. Hence, the inserting plate 44 holds on to its position while the digging plate 24 pushes away some of the soil 5, thus making a plant hole 52 in the soil 5. The plant hole 52 is precisely located in a desired position as the inserting plate 44 holds on to its position during the dibbling.

During the pivoting of the shovel 24, the lateral plates 221 of the blocking element 22 and the lateral plates 42 of the anchor 4 keep another amount of the soil 5 out of the plant hole 52. Hence, the capacity of the plant hole 52 is kept until the dibbler is moved out of the plant hole 52.

A plant 6 is cast into the tube 1. The plant 6 travels down the tube 1 and falls into the plant hole 52. Then, the dibbler is lifted from the soil 5 to allow the soil 5 to fill the plant hole 52. Thus, the plant 6 is planted in the desired position efficiently and precisely.

The flip 511 is pushed away by the digging plate 244 as mentioned above. That is, the plant hole 52 is clear of the flip 511. After the dibbler is moved out of the plant hole 52, the flip 511 cannot restore its position since it is cut from the weed barrier 51 by the anchor 4. Hence, the flip 511 cannot cover the plant 6 planted in the plant hole 52. No other portion of the weed barrier 51 is pushed away by the anchor 4 during the dibbling. Hence, no other portion of the weed barrier 51 will cover the plant 6 planted in the plant hole 52 after the dibbler is moved out of the plant hole 52. The plant 6 is allowed to conduct photosynthesis in the sun.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A dibbler comprising:
a tube;
a digging unit connected to a lower end of the tube and formed with a digging portion; and
a handle unit connected to the tube and the digging unit; and
an anchor connected to the digging unit and formed with a tip extending beyond than the digging portion.

2. The dibbler according to claim 1, wherein the anchor comprises two lateral plates and an inserting plate formed between the lateral plates.

3. The dibbler according to claim 2, wherein the inserting plate includes a shank extending opposite to the tip, wherein the shank is connected to the digging unit.

4. The dibbler according to claim 1, wherein the tip is made sharp to facilitate insertion of the inserting plate into soil.

5. The dibbler according to claim 1, wherein the digging unit comprises:
a blocking element connected to the tube; and
a shovel located in and movably connected to the blocking element.

6. The dibbler according to claim 5, wherein the digging unit comprises:
a stationary handle connected to at least one of the tube and the blocking element; and
a movable handle connected to the shovel and operable to move the shovel between a first position and a second position.

7. The dibbler according to claim 5, wherein the blocking element comprises two lateral plates and a middle plate formed between the lateral plates.

8. The dibbler according to claim 7, wherein the shovel comprises two lateral plates and a digging plate formed between the lateral plates, wherein the digging portion is formed at an end of the digging plate.

9. The dibbler according to claim 8, wherein each of the lateral plates of the blocking element comprises an aperture for receiving a fastener for connecting the lateral plates of the shovel to the lateral plates of the blocking element.

10. The dibbler according to claim 2, wherein the digging unit comprises a blocking element connected to the tube and formed with two lateral plates and a middle plate extending between the lateral plates, wherein the lateral plates of the blocking element are connected to the lateral plates of the anchor.

11. The dibbler according to claim 10, comprising a fastener inserted in the lateral plates of the blocking element and the lateral plates of the anchor.

12. The dibbler according to claim 11, wherein the digging plate of the shovel is located between the middle plate of the positioning element and the fastener so that the pivoting of the shovel is limited between the middle plate of the positioning element and the fastener.

13. The dibbler according to claim 11, wherein each of the lateral plates of the blocking element comprises an aperture for receiving the fastener.
